(19) United States
(12) Patent Application Publication
(10) Pub. No.: US 2013/0275281 A1
(43) Pub. Date: Oct. 17, 2013

(54) Method and System of Detecting Invalid Homestead Exemptions

(71) Applicant: Alison K. Jimenez, Tampa, FL (US)

(72) Inventor: Alison K. Jimenez, Tampa, FL (US)

(21) Appl. No.: 13/611,887

(22) Filed: Sep. 12, 2012

Related U.S. Application Data
(60) Provisional application No. 61/533,324, filed on Sep. 12, 2011.

(51) Int. Cl. G06Q 40/00

(52) U.S. Cl. CPC G06Q 40/103
USPC 705/31

(57) ABSTRACT

Disclosed is a system and method for detecting invalid homestead exemptions. In a preferred embodiment, the system and method stores information about parcels in a geographic area and compares that information with public information concerning that geographic information. The public information may include tax information, residency information, valuation information, and other information.

### CROSS-REFERENCE TO RELATED APPLICATION

This application claims the benefit of provisional application No. 61/533,324, filed Sep. 12, 2011, the entire contents of which are incorporated by reference herein.

### BACKGROUND OF THE INVENTION

1. Technical Field

This disclosure relates to a method and system for detecting invalid homestead exemptions.

2. Description of the Background Art

Presently, property tax homestead exemptions in the United States are based on the assumption that the address (hereinafter referred to as “parcel”) claimed is the primary residence of the owner filing the exemption.

The prior art assumes that all owners are equally likely to commit exemption fraud. The prior art then looks at vast quantities of data related to the owner with all owner data receiving equal attention.

Since all parcel owners are not equally likely to fraudulently claim homestead exemptions, the distribution of invalid exemptions is not evenly allocated across parcels. For example, zip codes with large property value decreases have a higher rate of invalid exemptions than zip codes with smaller price fluctuations.

Therefore, it is an object of this disclosure to provide an improvement which overcomes the aforementioned inadequacies of the prior art systems and provides an improvement which is a significant contribution to the advancement of the detection of homestead exemption fraud art.

Another object of this invention is to provide a system to efficiently and accurately detect homestead exemption fraud.

The foregoing has outlined some of the pertinent objects of the disclosure. These objects should be construed to be merely illustrative of some of the more prominent features and applications of the intended invention. Accordingly, other objects and a fuller understanding of the disclosure may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, the disclosure comprises a system for detecting fraudulent homestead exemptions.

Specifically, the present disclosure establishes factors to determine which parcels (or parcels in a certain area such as zip code or census tract) have a higher likelihood of being claimed fraudulently. These factors may indicate which parcels are least likely to be an owner's primary residence. The present invention essentially profiles a parcel.

More specifically, factors used to decrease the risk of a property being fraudulently claimed as a homestead property include, but are not limited to the following:
a) Low average selling price in zip code or Census tract (“ZC/CT”);
b) Low average wages in ZC/CT;
c) High rental rate in ZC/CT;
d) High second home ownership rate in the zip code;
e) Unusually high or low average age in ZC/CT;
f) High concentration of ethnic groups with historical record of lower home ownership rates;
g) High unemployment;
h) High foreclosure and short sale percentages;
i) High home vacancy rates;
j) Homes in areas with large negative equity issues and/or price drops in recent years; and
k) Homes that use government assistance for purchase or rent subsidies.

The parcel characteristics are quantifiable which allows the weighing of factors that provide a higher “hit rate” for invalid exemptions. The weighing of characteristics creates a smaller and more accurate sample to test against public records. Prior art systems waste an inordinate amount of time checking the validity of exemptions that are, in fact, valid claims. Additionally, prior art systems rely on testing the owner's data (i.e. social security number), without consideration of the parcels' data regardless of owner.

The system of the present disclosure efficiently focuses attention on parcels most likely to be determined as fraudulent exemption claims. This limited selection of parcels is then compared against public records to determine who, if anyone was living in the home on January 1^{st} (or other applicable statutory dates).

The system of the present disclosure may ensure that focus on higher dollar exemptions can be scrutinized particularly since some homestead exemptions are based upon a percentage of a parcel's value. In those instances, the higher the value of the parcel, the higher the exemption value. This system will allow for an increased return of tax dollars for a smaller amount of time invested.

The system of the present disclosure may also be used in conjunction with census data to determine where large concentrations of seniors reside. With census data of this type of specificity, a determination of increased exemptions for senior citizen and low-income individuals can be attained.

The Lexis Nexis tool marketing material states that the expected fraudulent hit rate is 5-10%. The system of the present invention results in a 50% fraudulent hit rate. Current data from several counties have reported the number of invalid exemptions found, but have not reported number of valid exemptions or the amount to time spent determining whether or not a claim was fraudulent.

The following example more particularly describes the system of the present disclosure.

Consider homes in two census tracts in Tampa, Fla. Census Tract 1 is in an established neighborhood that has a 7% vacancy rate. Prices in the neighborhood have dropped 15% in the past three years, and unemployment is 6%. Census Tract 2 is in a new ex-urb subdivision where all the homes were built in 2006. The subdivision has 35% vacancy rate, prices have dropped 60% in the past three years, and unemployment is 18%.

All Census Tract 2 homestead exemptions can be weighed as more likely to be fraudulent than the homestead exemption claims in Census Tract 1. Current research shows that when the value of a home dramatically decreases, a homeowner may decide to simply “walk away” or abandon the property altogether. Additionally, homeowners in Tract 2 are three times as likely to have lost his or her job making the home unaffordable which could ultimately lead to foreclosure. Based on the foregoing, it is easy to see why homes in Tract 2 are five times as likely to be vacant for one reason or another as homes in Tract 1.

A significant advancement over the current prior art systems is the use of Vacant and Abandoned Home Registries (“registries”) as a public record to verify residency requirements. In the late 2000's many cities and counties noticed a rising number of vacant homes. This was due to the foreclosure crisis. Some owners walked away from a home that was financially “underwater” while other owners moved out when they received a foreclosure notice. Either way, the home was abandoned by the owner leaving the home vacant. The number of vacant homes caused many municipalities to enact ordinances requiring the registration of vacant homes. The registries generally include the date or registration, address, homeowner's name, mortgagee, servicer and property maintenance manager. The property maintenance manager is generally required to keep the home from incurring out-of-code violations by maintaining the grounds and pool, etc.

As noted above, homestead exemptions are granted only when the owner lives in the home as his or her primary residence. The registries provide a date when the home was first known to be vacant or not occupied by the owner. If a home is vacant, then it is not the owner's primary residence and therefore does not entitle a homestead exemption.

In summary, the system works by weighing parcel characteristics to determine the homestead exemptions most likely to be fraudulent and to save time and money in the process. Additionally, the system works to locate the most valuable dollar-wise fraudulent exemptions and by using registries of vacant properties to prove or disprove residency exemption claims.

The foregoing has outlined rather broadly some of the more pertinent and important features of the present disclosure in order that the detailed description of the invention that follows may be better understood so that the present contribution to the art can be more fully appreciated. Additional features of the disclosure will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the disclosure, reference should be had to the following detailed description taken in connection with the accompanying drawing in which:

FIG. 1 is a flow chart depicting a methodology used in accordance with the teachings of the present disclosure; and

FIG. 2 is a diagram depicting a system in accordance with the present disclosure.

Similar reference characters refer to similar parts throughout the several views of the drawings.

### DETAILED DESCRIPTION OF THE PREFERRED EMBODIMENT

The present disclosure relates to a system and method for detecting invalid homestead exemptions. In a preferred embodiment, the system and method stores information about parcels in a geographic area and compares that information with public information concerning that geographic information. The public information may include tax information, residency information, valuation information, and other information.

In a preferred embodiment, real property information, wage information, and demographic information are stored in a database. Preferably, a computer system including a processor and memory is connected to a data storage device, such as a disk, flash drive, or other system capable of persisting digital data.

A system in accordance with the present disclosure can be implemented on one or more computing systems, which can include a personal computer, a workstation, a network computer, a hand held device, or any other computing system. Further, the system may be written as a software program in any appropriate computer language. As would be understood by one of skill in the art, the system may also include a memory capable of storing the steps necessary for a processing device to implement the steps disclosed herein. This memory could be in the form of memory resident within the processing device or in the form of standalone memory coupled to the processing unit via a communication path, such as a bus or a network.

The real property information persisted in the database may include selling price, rental rate, second home ownership rate, foreclosure percentage, short sale percentage, home vacancy rate, equity rate, and price information. Additional real property information may also be stored in the database.

Wage information may include average wages and information concerning unemployment. Demographic information may include geographic information and information about individuals living in or owning property in the respective area.

A system or method in accordance with the present disclosure will preferably compute parcel characteristics based upon the real property information, wage information, and demographic information. Parcel characteristics are preferably computed for a particular geographic area, such as a zip code or census tract.

Parcel characteristics may preferably include average selling price, average wages, rental rate, second home ownership rate, concentration of ethnic groups with historical record of lower home ownership rates, unemployment, foreclosure percentage, short sale percentage, home vacancy rates, negative equity rates, and price fluctuations. Other information may also be calculated and utilized as parcel characteristics.

An important feature of the present disclosure is the ability to weight the parcel characteristics. This weighting may be done based upon certain factors. These factors may be predetermined or may be configured or modified at a later time. In a preferred embodiment, the factors include for a particular geographic area: low average selling price, low average wages, high rental rate, high second home ownership rate, unusually high or low average age, high concentration of ethnic groups with historical record of lower home ownership rates, high unemployment, high foreclosure and short sale percentages, high home vacancy rates, and homes with large negative equity issues and/or price drops in recent years.

In a preferred embodiment, the weighted parcel characteristics are then compared against public records. For instance, the weighted parcel characteristics may be compared against tax roll information. Tax roll information may include information about properties in a geographic area including the exemption amount claimed for the property and the year in which that exemption amount was claimed. The weighted parcel characteristics may additionally be compared against residency information for the geographic area. Residency information may include information concerning whether or not the respective owners are residing in their properties. This information may be derived from utility bills, rental licenses, vacant home registries, or other available sources of information.

A system and method in accordance with the present disclosure may weight the parcels in a geographic area by determining a target area with a higher likelihood of invalid homestead exemptions. A system and method in accordance with the present disclosure may determine an area with a higher likelihood of invalid homestead exemptions based upon vacancy rates, rental rates, unemployment, foreclosures, sales price drops, and other similar information. In one preferred embodiment, a system and method in accordance with the present disclosure may determine a geographic area with high value properties in the same geographic area as parcels with a higher likelihood of invalid homestead exemptions. Preferably, the system and method cross-references high value property areas with high likelihood of invalid homestead exemption areas to determine target areas.

A system and method in accordance with the present disclosure will preferably gather public information for parcels in the target area to determine parcels with a higher likelihood of having invalid homestead exemptions. The system and method may also preferably report this information to a user. For instance, the information may be displayed on a computer display, or may be provided to a user through another mechanism.

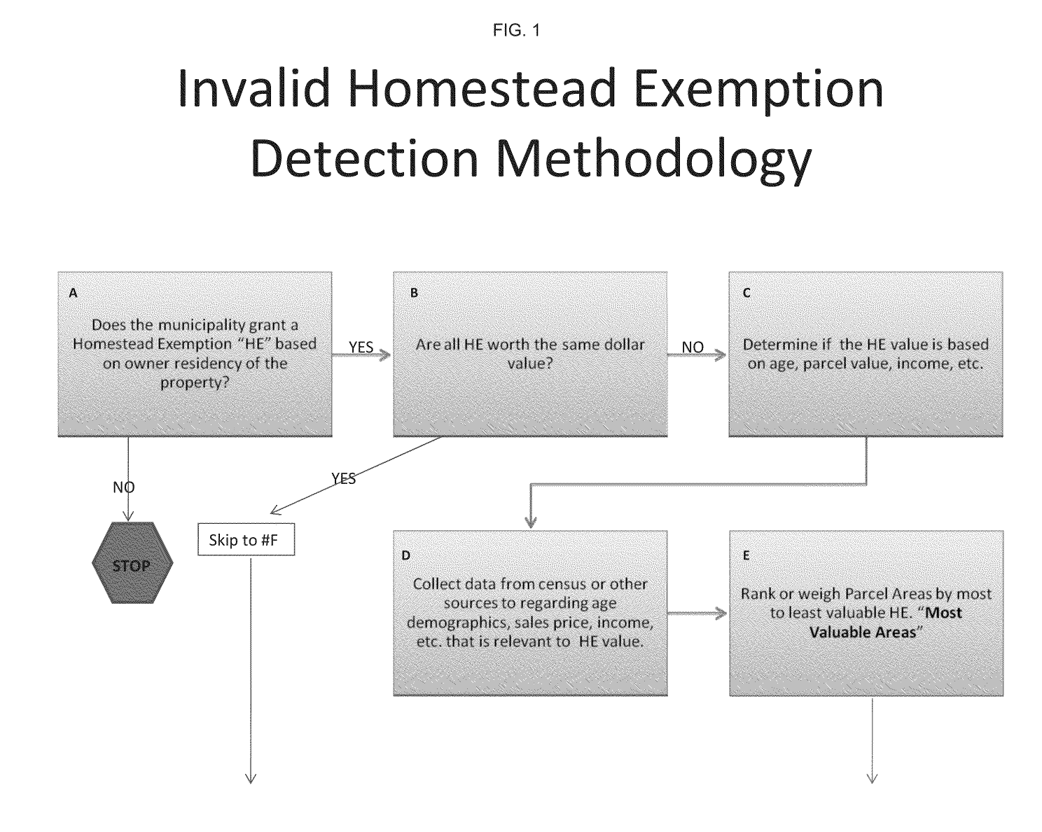

FIG. 1 illustrates a flow chart in accordance with the teachings of the present disclosure. If the municipality does not grant homestead exemptions, then the method need proceed no further at step A. If homestead exemptions are worth the same dollar amount for all, then the system may jump ahead at step B.

At step C, a homestead exemption amount is determined for the parcel. Information relevant to this homestead exemption is then collected from public sources at step D. In the preferred embodiment depicted in FIG. 1, the parcels in the system are then ranked based upon their value at step E.

Next, data is gathered which may bear upon whether or not properties in the area are more likely to have invalid homestead exemptions at step F. This information may include publicly available information including vacancy rates, rental rates, unemployment rates, foreclosures, sales price drops, and other related information.

At step G, the parcels are ranked or weighted based upon the data gathered in step F. This ranking will preferably order the parcels most likely to receive invalid homestead exemptions.

The parcels most likely to receive invalid homestead exemptions determined in step G is then cross referenced against the high value areas determined in step E to determine a target area at step H. One advantage of this approach is that the system and method focuses on likely invalid homestead exemptions in higher value parcel areas so as to maximize the municipalities advantages in utilizing a system and method in accordance with the present teachings.

At step I, tax information is gathered related to parcels in the target area. Residency data is then gathered related to parcels in the target area at step J. Address information may also be converted to an appropriate United States Parcel Service numerical identifier.

A system or method in accordance with the present disclosure may then compare the tax information and residency data to find matching addresses that have homestead exemptions. It should be noted that the time period (i.e. year) should be matched up to verify that the particular owner owned a property at a particular time, claimed a homestead exemption for that same time period, and resided in that home at that time period.

At step L, those owners whose tax information and residence information matches may be excluded from the list of properties estimated to have invalid homestead exemptions. At step M, those properties with anomalies among the tax information, residency data, and homestead exemption claims may be flagged or subjected to further review.

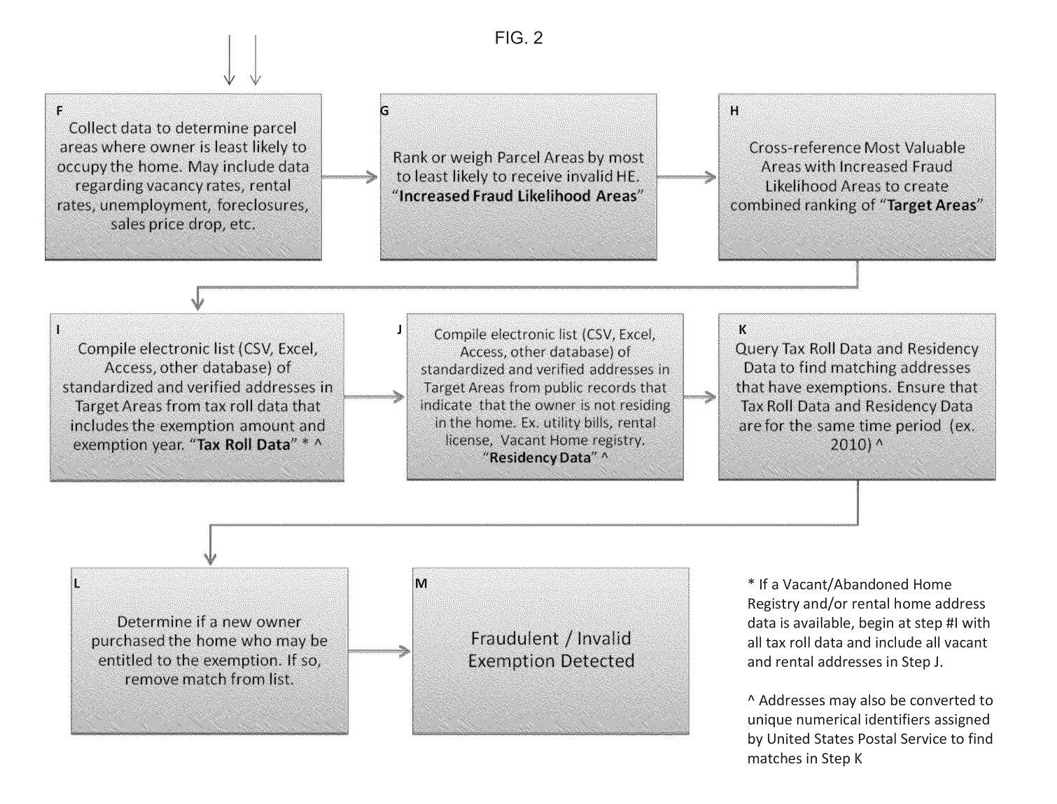

FIG. 2 is a high-level diagram of a system in accordance with the present disclosure.

The present disclosure includes that contained in the appended claims, as well as that of the foregoing description. Although this disclosure has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the disclosure has been described,

What is claimed is:

1. A method for detecting invalid homestead exemptions, the method comprising the following steps:
Storing in a first database real property information relating to parcels, wage information, and demographic information,
wherein the real property information comprises selling price, rental rate, second home ownership rate, foreclosure percentage, short sale percentage, home vacancy rate, equity rate, and price information;
wherein the wage information comprises average wages, and unemployment information;
wherein the demographic information comprises geographic information, and age information;
computing from the real property information, wage information, and demographic information stored in the first database parcel characteristics,
wherein parcel characteristics comprises the following within a geographic area: average selling price, average wages, rental rate, second home ownership rate, concentration of ethnic groups with historical record of lower home ownership rates, unemployment, foreclosure percentage, short sale percentage, home vacancy rates, negative equity rates, and price fluctuation;
assigning weights to the parcel characteristics to filter out a category of parcels to exclude from determining an invalid homestead exemption; and
comparing the weighted parcel characteristics against public records to estimate invalid homestead exemptions.

2. A method for detecting invalid homestead exemptions the method comprising the following steps:
storing information relating to parcels, wage information, and demographic information;
computing parcel characteristics from the information, wage information, and demographic information;
weighing the parcel characteristics based upon factors;
comparing the weighted parcel characteristics against public records to determine homestead exemptions most likely to be invalid.

3. The method of claim 2 wherein storing information relating to parcels, wage information, and demographic information comprises storing data in a database.

4. The method of claim 2 wherein the factors are predetermined.

5. The method of claim 2 wherein the factors are received from a user.

6. The method of claim 2 wherein the factors are retrieved from a database.

7. The method of claim 2 wherein weighing the parcel characteristics comprises:
determining high valuable parcel areas.

8. The method of claim 2 wherein weighing the parcel characteristics comprises:
determining parcel areas where parcels are least likely to be occupied.

9. The method of claim 2 wherein weighing the parcel characteristics comprises:
determining high valuable parcel areas and parcel areas where parcels are least likely to be occupied; and
cross-referencing the high valuable parcel areas with the parcel areas least likely to be occupied to generate a target area ranking.

10. The method of claim 9 wherein the public records comprises tax information concerning parcels in the target area.

11. The method of claim 9 wherein the public records comprises residency information concerning parcels in the target area.

12. The method of claim 9 wherein the public records comprises tax information and residency information concerning parcels in the target area.

13. The method of claim 12 wherein comparing the weighted parcel characteristics comprises comparing the tax information and residency information.

14. A system for detecting invalid homestead exemptions comprising:
a database for storing real property information relating to parcels, wage information, and demographic information;
a processing unit communicatively connected to the database wherein the processing unit is configured to compute weighted parcel characteristics from the sales information, wage information, and demographic information; and
wherein the processing unit further configured to compare the weighted parcel characteristics against public records to estimate invalid homestead exemption.

15. The system of claim 14 further comprising:
a second database wherein the processing unit is configured to store the estimated invalid homestead exemption in the second database.

16. The system of claim 15 wherein the second database is the same database as the first database.

17. The system of claim 14 further comprising a reporting module.

18. The system of claim 17 wherein the reporting module is a display.

19. The system of claim 14 wherein the processing unit is further configured to:
determine a target area; and
use the target area in estimating invalid homestead exemptions.

20. The system of claim 19 wherein the processing unit is further configured to estimate invalid homestead exemptions based upon tax information and residency information for parcels within the target area.
